(19) United States
(12) Patent Application Publication
(10) Pub. No.: US 2022/0223900 A1
(43) Pub. Date: Jul. 14, 2022

(54) MULTILAYER ELECTRODE-ELECTROLYTE COMPONENTS AND THEIR PRODUCTION METHODS

(71) Applicant: HYDRO-QUÉBEC, Montréal, Québec (CA)

(72) Inventors: Andrea PAOLELLA, Montreal, Québec (CA); Sylvio SAVOIE, Ste-Julie, Québec (CA); Gabriel GIRARD, Longueuil, Québec (CA); Amélie FORAND, Boucherville, Québec (CA); Wen ZHU, Brossard, Québec (CA); Abdelbast GUERFI, Brossard, Québec (CA); Karim ZAGHIB, Longueuil, Québec (CA)

(73) Assignee: HYDRO-QUÉBEC, Montréal, Québec (CA)

(21) Appl. No.: 17/607,492

(22) PCT Filed: May 1, 2020
(86) PCT No.: PCT/CA2020/050586

§ 371 Date: Oct. 29, 2021

Related U.S. Application Data
(60) Provisional application No. 62/842,963, filed on May 3, 2019.
(60) Provisional application No. 62/955,679, filed on Dec. 31, 2019.

(51) Int. Cl. H01M 10/058; H01M 10/0525; H01M 4/131; H01M 4/136; H01M 4/583; H01M 4/04; H01M 4/36

(52) U.S. Cl. CPC H01M 10/058; H01M 10/0525; H01M 4/131; H01M 2300/0068; H01M 4/583; H01M 4/0471; H01M 4/364; H01M 4/136

(57) ABSTRACT

Described are multilayer components comprising a solid electrolyte layer and a solid electrode layer, both comprising ceramic particles while being polymer-free as well as electrochemical cells comprising them. The processes for preparing these multilayer components, which use a hot-pressing step, are also described.

### RELATED APPLICATIONS

The present application claims priority, under the applicable law, to U.S. provisional patent application Nos. 62/842,963 and 62/955,679 filed respectively on May 3, 2019 and Dec. 31, 2019, the content of which is incorporated herein by reference in its entirety and for all purposes.

### TECHNICAL FIELD

The technical field generally relates to processes for preparing solid-state multilayer elements comprising an electrode layer and an electrolyte layer, to the elements obtained by these processes and to electrochemical cells comprising them.

### TECHNICAL BACKGROUND

Liquid electrolytes based on flammable liquids, such as ethylene or diethyl carbonate, widely used in lithium-ion batteries can ignite, for instance, when the temperature in the cell increases (Guerfi et al., J. Power Source 195, 845-852 (2010)) and therefore often lead to unsafe batteries. These liquid electrolytes also allow the formation of dendrites and require the use of separators with varying success.

Solid electrolytes have been developed, for instance, based on polymers (mainly polyethylene oxide-based, see Commarieu et al., Curr. Opin. Electrochem. 9, 56-63 (2018)) or ceramics such as cubic Li₇La₃Zr₂O₁₂ (LLZO) doped with gallium (see Rawlence et al., ACS Appl. Mater. Interfaces 10, 13720-13728 (2018)), NASICON-type Li_{1.5}Al_{0.5}Ti_{1.5}(PO₄)₃ (LATP) (see Soman et al., J. Solid State Electrochem. 16, 1761-1766 (2012)), NASICON-type Li_{1.5}Al_{0.5}Ge_{1.5}(PO₄)₃ (LAGP) (see Zhang et al., J. Alloys Compd. 590, 147-152 (2014)) and Li₄₋ₓGe₁₋ₓPₓS₄ thio-LISICON (see Kanno & Murayama, J. Electrochem. Soc. 148, 742-746 (2001)). A hybrid solid electrolyte based on a ceramic and a polymer may also be used to obtain improved mechanical strength and ionic conductivity (Wang et al., ACS Appl. Mater. Interfaces 9, 13694-13702 (2017)).

Densification of solid electrolytes is a key element in blocking the formation of lithium metal dendrites. It was shown that the use of hot-pressing as a tool could reduce grain boundary resistance in an LLZO electrolyte (see David et al., J. Am. Ceram. Soc. 1214, 1209-1214 (2015)). However, the best results presented were obtained at a temperature that could reach up to 1100° C. Some groups have reported hot-pressing methods to densify the NASICON type LAGP solid electrolyte. A multi-step process has been described for the densification of LAGP by hot-pressing at 600° C. under argon at a pressure of 20 MPa followed by a step of sintering in air at 800° C. for 8 hours to form a LAGP rod (see Kotobuki et al., RSC Adv., 11670-11675 (2019)). The rod is then sliced with a diamond wire to provide a thin electrolyte film.

Nevertheless, the final preparation of a solid state cathode is still difficult, as the sintering of a cathode material in the presence of oxygen would likely burn off any carbon present. In 2018, another group described a fully phosphate-based battery based on Li_{1.3}Al_{0.3}Ti_{1.7}(PO₄)₃ (Yu et al., ACS Appl. Mater. Interfaces 10, 22264-22277 (2018)). In this case, the authors prepared an LATP electrolyte pellet by cold pressing followed by sintering at 1100° C. in air atmosphere. The electrolyte layer was then prepared by spreading by screen-printing, repeated several times, of a suspension composed of LiTi₂(PO₄)₃, Li_{1.3}Al_{0.3}Ti_{1.7}(PO₄)₃, carbon black, and ethylcellulose as a binder (45:25:15:15) in NMP as a solvent and its drying. The cathode was prepared following the same method, replacing LiTi₂(PO₄)₃ by Li₃V₂(PO₄)₃. The battery was then subjected to cold isostatic pressing at 504 MPa for 30 seconds and dried again at 120° C.

Cold sintering processes for the preparation of solid electrolytes and solid electrodes individually were also reviewed in Liu et al., J. Power Sources 393, 193-203 (2018) using various materials with quite variable results.

Therefore, there is a need for novel processes for the preparation of solid state battery components, these processes improving at least one aspect of the foregoing processes.

### SUMMARY

The present document relates to a process for preparing multilayer components and electrochemical cells comprising such components, to the multilayer components prepared therefrom, and to the electrochemical cells and batteries containing them.

According to one aspect, the process for preparing a multilayer component comprising a solid electrode layer and a solid electrolyte layer, comprises at least the steps of:
a) preparing the solid electrolyte layer by compressing ceramic particles;
b) preparing a mixture comprising at least an electrochemically active material, ceramic particles, and an electron conductive material, the mixture being free of solvent;
c) applying the mixture obtained in (b) on the solid electrolyte layer prepared in (a) to obtain a bilayer material;
d) pressing the bilayer material obtained in (c) at a pressure of at least 50 kg/cm² and a temperature of within the range of about 400° C. to about 900° C.

In one embodiment, step (a) excludes the addition of a solvent. In another embodiment, step (a) excludes the addition of a lithium salt. In a further embodiment, the solid electrolyte layer and the electrode layer are both free of polymer after step (d). According to another embodiment, step (b) also excludes the addition of a solvent. According to some embodiments, the mixing step (b) is carried out by ball milling.

In another embodiment, the ceramic of step (a) is of formula Li_{1+z}Al_{z}M_{2-z}(PO₄)₃, wherein M is Ti, Ge, or a combination thereof, and z is such that 0<z<1. In one embodiment, M is Ge. In another embodiment, M is Ti. According to a further embodiment, step (a) is carried out in the presence of oxygen (for example, in air). In yet another embodiment, step (a) is carried out at a pressure of between 100 kg/cm² and 5000 kg/cm².

In a further embodiment, step (d) is carried out in an inert atmosphere (e.g., argon, nitrogen). In another embodiment, step (d) is carried out at a pressure of between 50 kg/cm² and 5000 kg/cm², or between 100 kg/cm² and 5000 kg/cm², or between 300 kg/cm² and 2000 kg/cm². In yet another embodiment, step (d) is carried out at a temperature of between about 450° C. and about 850° C., or between about 600° C. and about 700° C. In another embodiment, step (d) is carried out for a period of more than 0 hour and less than 10 hours, or between 30 minutes and 5 hours, or between 30 minutes and 2 hours.

In one embodiment, the electrode layer is a positive electrode layer. In an embodiment, the electrochemically active material in the electrode layer is selected from phosphates (e.g. LiM^{a}PO₄ where M^{a} is Fe, Ni, Mn, Co, or a combination thereof), oxides and complex oxides such as LiMn₂O₄, LiM^{b}O₂ (M^{b} being Mn, Co, Ni, or a combination thereof), and Li(NiM^{c})O₂ (M^{c} being Mn, Co, Al, Fe, Cr, Ti, Zr, or a combination thereof), elemental sulfur, elemental selenium, iron(III) fluoride, copper(II) fluoride, lithium iodide, and iodine. For instance, the electrochemically active material of the positive electrode may be a phosphate LiM^{a}PO₄ where M^{a} is Fe, Mn, Co or a combination thereof (e.g., LiFePO₄), wherein said electrochemically active material is made of particles optionally further coated with carbon.

According to other embodiments, the electron conductive material in the electrode layer is selected from the group consisting of carbon black, Ketjen™ black, acetylene black, graphite, graphene, carbon fibers or nanofibers (for example, VGCF), carbon nanotubes, and a combination thereof, for instance, the electron conductive material comprises carbon fibers (such as VGCF).

In another embodiment, the ceramic particles of step (b) comprise a ceramic of formula Li_{1+z}Al_{z}M_{2-z}(PO₄)₃, wherein M is Ti, Ge or a combination thereof, and 0<z<1. In one example, M is Ge. In another example, M is Ti.

In a variation of interest, the ceramic of step (a) and the ceramic particles of step (b) are identical.

According to another aspect, the present document relates to a process for preparing a multilayer component comprising a solid electrode layer and a solid electrolyte layer, said process comprising at least the steps of:
a) preparing an electrolyte composition layer by applying a mixture of ceramic particles and a polymer on a first support;
b) preparing a mixture comprising at least an electrochemically active material, ceramic particles, an electron conductive material, and optionally a polymer;
c) applying the electrode material mixture prepared in step (b):
   i. on the electrolyte composition layer prepared in (a); or
   ii. on a second support followed by contacting a surface of the applied electrode material mixture with a surface of the electrolyte composition layer;
to afford a bilayer material;
d) pressing the bilayer material obtained in (c) at a pressure of at least 50 kg/cm² and a temperature of between about 400° C. and about 900° C.

In one embodiment, step (a) of the process excludes the addition of a solvent. Alternatively, step (a) of the process further comprises a solvent and further comprises drying the mixture after application. In another embodiment, step (a) further comprises removing the first support. In yet another embodiment, step (a) excludes the addition of a lithium salt. According to an embodiment, the polymer of step (a) and step (b) if present is, independently in each occurrence, selected from a fluorinated polymer (such as le polyvinylidene fluoride (PVDF), or poly(vinylidene fluoride-co-hexafluoropropylene) (PVDF-HFP)), a poly(alkylene carbonate) (such poly(ethylene carbonate) or poly(propylene carbonate)), a polyvinyl butyral (PVB), or a polyvinyl alcohol (PVA). For example, the polymer is a poly(alkylene carbonate) (such as poly(ethylene carbonate) or poly(propylene carbonate)).

According to a further embodiment, the solid electrolyte layer and the electrode layer are free of polymer after step (d).

In another embodiment, the ceramic of step (a) is of formula Li_{1+z}Al_{z}M_{2-z}(PO₄)₃, wherein M is Ti, Ge, or a combination thereof, and 0<z<1. In one embodiment, M is Ge. In another embodiment, M is Ti. In a further embodiment, step (a) further comprises pressing the mixture in the presence of oxygen (e.g., in air), for instance, at a pressure of between 100 kg/cm² and 5000 kg/cm².

In a further embodiment, the process comprises step (c) (ii) and the process comprises removing the first and second supports before contacting the electrode material layer with the solid electrolyte layer. Alternatively, the process comprises step (c) (ii) and the process comprises removing the first and second supports after contacting the electrode material layer with the solid electrolyte layer.

In yet another embodiment, the process further comprises laminating the bilayer material between rolls before step (d).

According to other embodiments, step (b) further comprises a solvent and step (c) further comprises drying the applied electrode material. In another embodiment, step (b) comprises dry mixing the electrochemically active material, ceramic particles, and electron conductive material, suspending the resulting mixture with a polymer in a solvent, and step (c) further comprises drying the applied electrode material.

In another embodiment, step (d) is carried out in an inert atmosphere (for example, in argon, nitrogen). In a further embodiment, step (d) is carried out at a pressure of between 50 kg/cm² and 5000 kg/cm², or between 100 kg/cm² and 5000 kg/cm², or between 300 kg/cm² and 2000 kg/cm². In yet another embodiment, step (d) is carried out at a temperature of between about 450° C. and about 850° C., or between about 600° C. and about 750° C. In another embodiment, step (d) is carried out for a period of more than 0 hour and less than 10 hours, or between 30 minutes and 5 hours, or between 30 minutes and 2 hours.

In one embodiment, the electrode layer is a positive electrode layer. In an embodiment, the electrochemically active material in the electrode layer is selected from phosphates (for example LiM^{a}PO₄ where M^{a} is Fe, Ni, Mn, Co, or a combination thereof), oxides and complex oxides such as LiMn₂O₄, LiM^{b}O₂ (M^{b} being Mn, Co, Ni, or a combination thereof), and Li(NiM^{c})O₂ (M^{c} being Mn, Co, Al, Fe, Cr, Ti, Zr, or a combination thereof), elemental sulfur, elemental selenium, iron(III) fluoride, copper(II) fluoride, lithium iodide, and iodine. For instance, the electrochemically active material of the positive electrode may be a phosphate LiM^{a}PO₄ where M^{a} is Fe, Mn, Co or a combination thereof (such as LiFePO₄), wherein said electrochemically active material is made of particles optionally coated with carbon.

In further embodiments, the electron conductive material in the electrode layer is selected from the group consisting of carbon black, Ketjen™ black, acetylene black, graphite, graphene, carbon fibers or nanofibers (for example, VGCF), carbon nanotubes, and a combination thereof. In one example, the electron conductive material comprises carbon fibers (like VGCF). In another example, the electron conductive material comprises graphite.

In yet another embodiment, the ceramic particles of step (b) comprise a ceramic of the formula Li_{1+z}Al_{z}M_{2-z}(PO₄)₃, wherein M is Ti, Ge, or a combination thereof, and 0<z<1. In one example, M is Ge. In another example, M is Ti.

In an interesting variation, the ceramic in step (a) and the ceramic in step (b) are identical.

According to another aspect, the present document relates to a multilayer component obtained by a process as defined herein.

According to a further aspect, this document relates to a multilayer component comprising a solid electrode layer and a solid electrolyte layer, wherein:
the solid electrolyte layer comprises ceramic particles;
the solid electrode layer comprises an electrochemically active material, ceramic particles, and an electron conductive material; and
the solid electrode layer and the solid electrolyte layer are free of polymer electrolyte and polymer binder.

In one embodiment, the ceramic in the solid electrolyte layer is of formula Li_{1+z}Al_{z}M_{2-z}(PO₄)₃, wherein M is Ti, Ge, or a combination thereof, and 0<z<1. In one example, M is Ge. In another example, M is Ti.

In one embodiment, the electrode is a positive electrode. In one embodiment, the electrochemically active material is selected from phosphates (for example, LiM^{a}PO₄ where M^{a} is Fe, Ni, Mn, Co, or a combination thereof), oxides and complex oxides such as LiMn₂O₄, LiM^{b}O₂ (M^{b} being Mn, Co, Ni, or a combination thereof), and Li(NiM^{c})O₂ (M^{c} being Mn, Co, Al, Fe, Cr, Ti, Zr, or a combination thereof), elemental sulfur, elemental selenium, iron(III) fluoride, copper(II) fluoride, lithium iodide, and iodine. For example, the electrochemically active material of the positive electrode may be a phosphate LiM^{a}PO₄ where M^{a} is Fe, Mn, Co or a combination thereof (such as LiFePO₄), wherein the electrochemically active material consists of particles optionally coated with carbon.

In a further embodiment, the electron conductive material is selected from the group consisting of carbon black, Ketjen™ black, acetylene black, graphite, graphene, carbon fibers or nanofibers (for example, VGCF), carbon nanotubes, and a combination thereof.

In one example, the electron conductive material comprises carbon fibers (such as VGCF). In another example, the electron conductive material comprises graphite.

In yet another embodiment, the ceramic particles in the solid electrode layer comprise a ceramic of the formula Li_{1+z}Al_{z}M_{2-z}(PO₄)₃, wherein M is Ti, Ge, or a combination thereof, and 0<z<1. In one example, M is Ge. In another example, M is Ti.

In a preferred embodiment, the ceramic particles in the solid electrolyte layer and the ceramic particles in the solid electrode layer are identical.

In a further embodiment, the multilayer component described herein or prepared by a process described herein comprises a high contact at the interface between the solid electrolyte layer and the solid electrode layer, i.e., an intimately fused interface.

In yet another embodiment, the multilayer component described herein or prepared by one of the present processes has a high density, for instance, where at least one layer of the multilayer component has a density of at least 90% of the theoretical density, for example, the multilayer component has a density of at least 90% of the theoretical density.

In a further aspect, the present document describes an electrochemical cell comprising a negative electrode, a positive electrode and an electrolyte, where the electrolyte and positive electrode together form a multilayer component as defined herein. In one embodiment, the negative electrode comprises a lithium or lithium alloy film and a polymer interlayer between the lithium or lithium alloy film and the solid electrolyte layer. For instance, the polymer interlayer comprises a polyether polymer and a lithium salt, such as an optionally crosslinked PEO-based polymer and a lithium salt (e.g., LiTFSI).

According to another aspect, the present relates to a process for preparing an electrochemical cell comprising the steps of:
(i) preparing a multilayer component according to a process as defined herein; and
(ii) assembling the multilayer component of step (i) with a negative electrode layer.

In one embodiment, the negative electrode layer comprises a lithium or lithium alloy film and a polymer interlayer between the lithium or lithium alloy film and the solid electrolyte layer. For example, the polymer interlayer comprises a polyether polymer and a lithium salt, such as an optionally crosslinked PEO-based polymer and a lithium salt (such as LiTFSI).

A further aspect relates to a battery comprising at least one electrochemical cell as defined herein, for example, a lithium battery or a lithium-ion battery.

### BRIEF DESCRIPTION OF THE FIGURES

FIG. 1 schematically illustrates an embodiment of the present process.

FIG. 2 displays the X-ray diffraction pattern of (a) LAGP before sintering and (b) LAGP after sintering at 1000° C.

FIG. 3 displays the first two charge/discharge curves of a cell prepared according to an embodiment of the present process when cycled at a current of 100 μA.

FIG. 4 shows charge/discharge curves of a cell prepared according to the embodiment described in Example 2.

### DETAILED DESCRIPTION

The following detailed description and examples are illustrative and should not be interpreted as further limiting the scope of the invention.

All technical and scientific terms and expressions used herein have the same definitions as those commonly understood by the person skilled in the art when relating to the present technology. The definition of some terms and expressions used is nevertheless provided below for clarity purposes.

When the term “about” is used herein, it means approximately, in the region of, and around. When the term “about” is used in relation to a numerical value, it modifies it, for example, above and below its nominal value by a variation of 10%. This term may also take into account the probability of random errors in experimental measurements or rounding of a number.

The expressions “free of polymer”, “free of polymer binder”, “excluding a polymer”, or “excluding a polymer binder” are equivalents and mean that the characterised material, being either the electrolyte or an electrode, does not contain a polymer commonly used in electrolytes or as electrode material binder (for example, a PEO-based polymer, fluorinated polymer, poly(alkylene carbonate), polyvinyl butyral, polyvinyl alcohol, etc.). The expression does not, however, intend to exclude carbon-based macromolecules (such as graphene, carbon nanotubes, carbon fibers, etc.) which would serve as electronically conductive materials in electrode materials.

The term “support” as used herein defines a material, generally in the form of a film or foil, on which a mixture, such as a slurry, is applied. The support material is unreactive to the mixture applied thereon. Examples of materials used as support include polymer supports such as polypropylene, polyethylene and other inert polymers.

The term “lithium salt” as used herein refers to any lithium salt that can be used in solid electrolytes of electrochemical cells. Non-limiting examples of lithium salts comprise lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyano-imidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃] (LiFAP), lithium tetrakis(trifluoroacetoxy)borate Li[B(OCOCF₃)₄] (LiTFAB), or lithium bis(_{1,2}-benzenediolato(2-)-O,O′)borate Li[B(C₆O₂)₂] (LBBB).

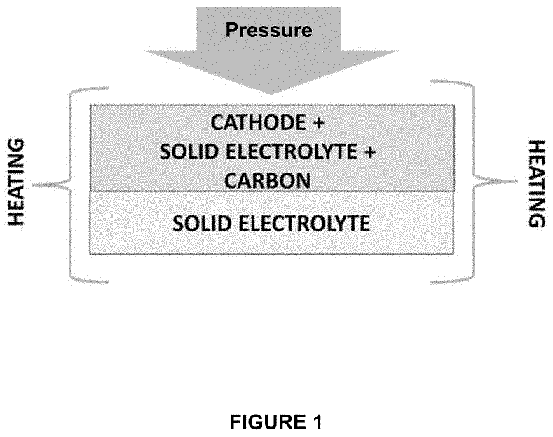

The present document relates to the preparation of solid multilayer electrode-electrolyte components. This process avoids the use of a polymer in the electrolyte or as a binder in the electrode of the final material. Two variations of this process are described here. The first variant does not include a polymer during the preparation of the multilayer, while the second eliminates the polymer used during a hot pressing step. Solvents are generally not required with the first variant of the process. FIG. 1 illustrates one embodiment of the process, showing that the solid electrode and electrolyte layers are hot-pressed together.

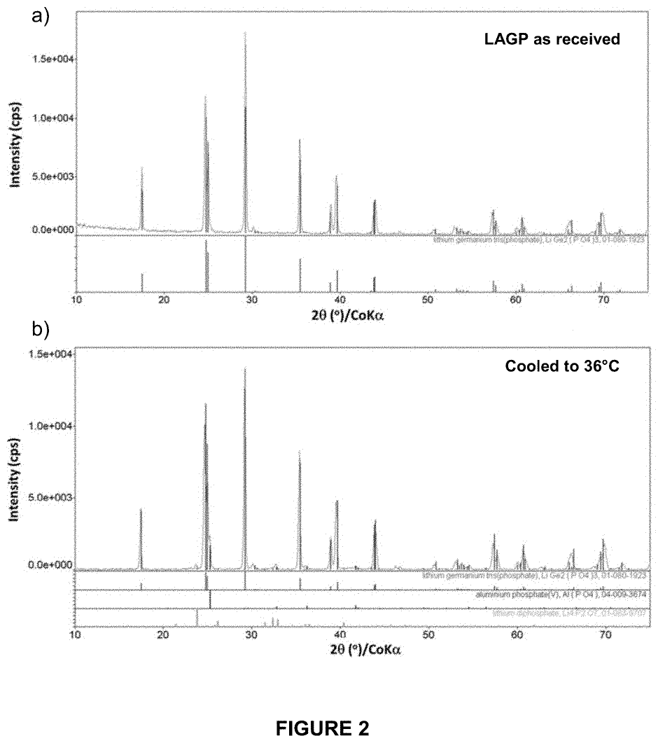

While sintering of cathode materials at high temperatures under oxygen may cause part of the cathode material to burn, it was found that LAGP and LATP are strongly affected when sintered under inert atmosphere. For these ceramics, gaseous oxygen would then be easily lost thereby forming germanium (II) or titanium (II) oxide and lithium phosphate impurities (see FIG. 2).

This document therefore presents a new process for the preparation of component comprising at least two layers including ceramic-based electrolyte and electrode layers for use in electrochemical applications. The process is simple and rather short. One of the variants also avoids the use of toxic and/or flammable solvents. It also ensures good contact at the interface between the electrolyte and electrode solid layers, where the two layers are intimately bonded (fused) to each other. The electrode-electrolyte solid component also possesses a density appropriate for its use in electrochemical cells.

An example of such a process for the preparation of a multilayer component comprises at least the steps of:
a) preparing a solid electrolyte layer by compressing particles comprising a ceramic;
b) preparing a mixture comprising at least an electrochemically active material, ceramic particles, and an electron conductive material, the mixture being free of solvent;
c) applying the mixture prepared in (b) on the solid electrolyte layer prepared in (a) to obtain a bilayer material;
d) pressing the bilayer material obtained in (c) at a pressure of at least 50 kg/cm², or between 50 kg/cm² and 5000 kg/cm², and at a temperature in the range of about 400° C. to about 900° C., or about 450° C. to about 850° C., or about 600° C. to about 700° C.

For instance, step (a) of the present process avoids the use of a solvent and/or lithium salt. The solid electrolyte layer and the solid electrode layer of the component are free of polymer (i.e., polymer of solid polymer electrolyte or polymer binder).

The present process may use any ceramic known to the person skilled art, the selected ceramic being suitable as an electrolyte ceramic and being stable under the present process conditions. For instance, the ceramic in the solid electrolyte layer may be of formula Li_{1+z}Al_{z}M_{2-z}(PO₄)₃, wherein M is Ti, Ge, or a combination thereof, and 0<z<1. According to one example, M is Ge. According to another example, M is Ti. For instance, z is in the range of 0.25 to 0.75, or of 0.1 to 0.9, or of 0.3 to 0.7, or of 0.4 to 0.6, or of about 0.5. The ceramic may have a NASICON-like structure.

The solid electrolyte layer may have a final thickness (after step (d)) below 1 mm, or in the range of 50 μm to 1 mm, or 50 μm to 500 μm, or 50 μm to 200 μm.

The solid electrolyte layer is preferably compressed in step (a) without external heating and in the presence of oxygen (e.g., in air). The bilayer material after addition of the electrode layer mixture is preferably hot-pressed in step (d) in an inert atmosphere (e.g., under argon nitrogen).

For example, step (a) may be carried out at a pressure in the range of 100 kg/cm² to 5000 kg/cm².

The hot-pressing step (d) may be carried for a period of more than 0 hour and less than 10 hours, or between 30 minutes and 5 hours, or between 30 minutes and 2 hours. The hot-pressing step may be performed in a heating chamber such as ovens, furnaces, etc. while applying pressure on at least one side of the bilayer material. Preferably, the hot-pressing step is carried out using a hot-pressing furnace, hot-press die, and the like. The bilayer material is generally included in a mold, and the pressure is applied uniaxially.

The mixing step (b) in the present process may be performed by any method known in the art such as ball milling, planetary mixer, etc. For instance, the mixing step may be carried out by ball milling using zirconia (zirconium dioxide) balls.

Alternatively, the process for preparing a multilayer component comprising a solid electrode layer and a solid electrolyte layer comprises at least the steps of:
a) preparing a solid electrolyte layer by the application of a mixture of ceramic particles and a polymer on a first support;
b) preparing a mixture comprising at least an electrochemically active material, ceramic particles, an electron conductive material, and optionally a polymer;
c) applying the electrode material mixture prepared in step (b):
   i. on the solid electrolyte layer prepared in (a); or
   ii. on a second support followed by contacting a surface of the applied electrode material mixture with a surface of the solid electrolyte layer;;
to afford a bilayer material;
d) pressing the bilayer material obtained in (c) at a pressure of at least 50 kg/cm² and a temperature of between about 400° C. and about 900° C.

Step (a) of the process may exclude the addition of a solvent. Alternatively, step (a) of the process further comprises a solvent and a step of drying the mixture after application. In one example, step (a) further comprises removing the first support. Preferably, step (a) excludes the addition of a lithium salt.

Non-limiting examples of polymers that may be used in step (a) and optionally step (b) (if present) comprise, independently in each occurrence, a fluorinated polymer (such as le polyvinylidene fluoride (PVDF), or poly(vinylidene fluoride-co-hexafluoropropylene) (PVDF-HFP)), a poly(alkylene carbonate) (such poly(ethylene carbonate) or poly(propylene carbonate)), a polyvinyl butyral (PVB), or a polyvinyl alcohol (PVA), for example, the polymer is a poly(alkylene carbonate) (such as poly(ethylene carbonate) or poly(propylene carbonate)). The solid electrolyte layer and the electrode layer are free of polymer after step (d).

The ceramic of step (a) is, for instance, of formula Li_{1+z}Al_{z}M_{2-z}(PO₄)₃, wherein M is Ti, Ge, or a combination thereof, and z is such that 0<z<1. Step (a) may further comprise pressing the mixture in the presence of oxygen (like oxygen from air), for instance, at a pressure of between 100 kg/cm² and 5000 kg/cm².

In one example, the process comprises step (c) (ii) and the process comprises removing the first support and the second support before contacting the electrode material layer with the solid electrolyte layer. Alternatively, the process comprises step (c) (ii) and the process comprises removing the first support and the second support after contacting the electrode material layer with the solid electrolyte layer.

The process preferably further comprises laminating the bilayer material between rolls before step (d).

In other examples, step (b) further comprises a solvent and step (c) further comprises drying the applied electrode material. For instance, step (b) can comprise dry mixing of the electrochemically active material, ceramic particles, and electron conductive material, suspending the resulting mixture with a polymer in a solvent, followed by drying of the applied electrode material.

Step (d) may be carried out under inert atmosphere (for example under argon, nitrogen). This step may also be carried out at a pressure of between 50 kg/cm² and 5000 kg/cm², or between 100 kg/cm² and 5000 kg/cm², or between 300 kg/cm² and 2000 kg/cm². The temperature applied in step (d) may be within the range of about 450° C. to about 850° C., or about 600° C. to about 750° C. This step is preferably carried out for a period of more than 0 hour and less than 10 hours, or between 30 minutes and 5 hours, or between 30 minutes and 2 hours.

The solid electrolyte layer may have a final thickness below 1 mm, or in the range of 50 μm to 1 mm, or of 50 μm to 500 μm, or of 50 μm to 200 μm. The combined thickness of the bilayer material, comprising the electrode layer and electrolyte is preferably below 1 mm, or within the range of 50 μm to 1 mm, or of 50 μm to 600 μm, or of 100 μm to 400 μm.

In either of the present processes, the electrode layer of the multilayer component is preferably a positive electrode. For example, the electrode layer contains between about 25 wt % and about 60 wt % of electrochemically active material, between about 25 wt % and about 60 wt % of ceramic particles, and between about 5 wt % and about 15 wt % of electron conductive material, the total being of 100%.

Non-limiting examples of electrochemically active material comprise phosphates (e.g. LiM^{a}PO₄ where M^{a} is Fe, Ni, Mn, Co, or a combination thereof), oxides and complex oxides such as LiMn₂O₄, LiM^{b}O₂ (M^{b} being Mn, Co, Ni, or a combination thereof), and Li(NiM^{c})O₂ (M^{c} being Mn, Co, Al, Fe, Cr, Ti, Zr, or a combination thereof), elemental sulfur, elemental selenium, iron(III) fluoride, copper(II) fluoride, lithium iodide, and iodine. In some examples, the electrochemically active material of the positive electrode is a phosphate LiM^{a}PO₄ where M^{a} is Fe, Mn, Co or a combination thereof (such as LiFePO₄), wherein said electrochemically active material is made of particles optionally further coated with carbon.

The electron conductive material included in the electrode layer may be selected from carbon black, Ketjen™ black, acetylene black, graphite, graphene, carbon fibers or nanofibers (for example, VGCF), carbon nanotubes, and a combination thereof. For instance, the electron conductive material comprises carbon fibers (such as VGCF) or graphite.

For instance, the ceramic particles in the electrode layer comprise a compound of the formula Li_{1+z}Al_{z}M_{2-z}(PO₄)₃, wherein M is Ti, Ge, or a combination thereof, and 0<z<1. In one example, M is Ge. In another example, M is Ti. For instance, z is between 0.25 and 0.75, or z is about 0.5.

In some examples, the ceramic in the solid electrolyte layer and the ceramic particles in the solid electrode layer comprise the same compound.

Multilayer components obtainable or obtained by the present process are also contemplated herein. For instance, the multilayer components comprise an intimately fused interface between the solid electrolyte layer and solid electrode layer. The solid electrolyte layer and solid electrode layer each possess a high density. For instance, the density of each at least one of the two layers is of at least 90% of the theoretical density.

The present document also relates to electrochemical cells comprising a negative electrode, a positive electrode and an electrolyte, wherein the electrolyte and positive electrode form a multilayer component as defined herein or obtained by the present process. For example, the negative electrode comprises a lithium or lithium alloy film and a polymer interlayer between the lithium or lithium alloy film and the solid electrolyte layer. The polymer interlayer may comprise, for instance, a polyether polymer and a lithium salt, such as an optionally crosslinked PEO-based polymer and a lithium salt (e.g. LiTFSI).

A process for preparing electrochemical cells as defined herein is also contemplated. Such a process comprises:
(i) preparing a multilayer component according to a process as defined herein; and
(ii) assembling the multilayer component of step (i) with a negative electrode layer.

For example, the negative electrode layer comprises a lithium or lithium alloy film and a polymer interlayer as described above between the lithium or lithium alloy film and the solid electrolyte layer.

The present description also describes a battery comprising at least one electrochemical cell as defined herein. For example, the battery is a lithium or lithium-ion battery.

The present technology also further relates to the use of the present electrochemical cells and batteries, for example, in mobile devices, such as mobile phones, cameras, tablets or laptops, in electric or hybrid vehicles, or in renewable energy storage.

### EXAMPLES

The following non-limiting examples are illustrative embodiments and should not be construed as further limiting the scope of the present invention. These examples will be better understood with reference to the accompanying figures.

### Example 1

(a) Solid Electrolyte-Cathode Component

Li_{1.5}Al_{0.5}Ge_{1.5}(PO₄)₃ (0.75 g, LAGP) powder is cold-pressed under air in a 16 mm titanium-zirconium-molybdenum (TZM) mold with 5 tons (5000 kg) of weight to form a LAGP electrolyte pellet. An amount of 0.75 g of a mixture containing carbon-coated LiFePO₄ (45 wt %), LAGP (45 wt %), and vapor-grown carbon fibers (VGCF, 10 wt %), is added on the LAGP electrolyte pellet to form a bilayer material. This bilayer material is then pressed in a hot press at 650° C. for 1 hour with 2 tons (2000 kg) of pressure under inert atmosphere to give the solid electrolyte-cathode component.

(b) All Solid-State Electrochemical Cell

The solid electrolyte-cathode component obtained in (a) is assembled with a metallic lithium film and a protective layer comprising PEO and lithium bis(trifluoromethanesulfonyl)imide (LiTFSI) (with an O/Li molar ratio of 20:1) between the metallic lithium anode and the ceramic electrolyte.

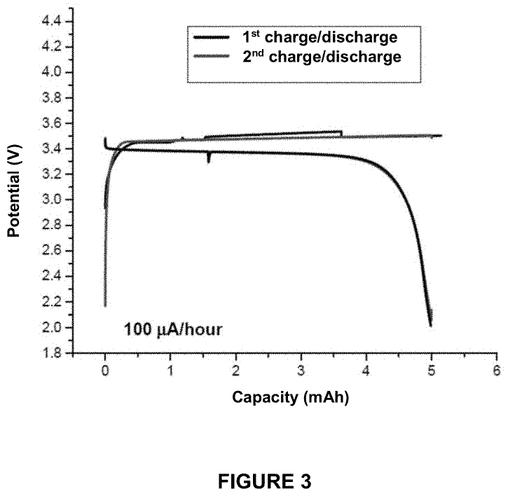

The cell was cycled at 100 μA with charge/discharge results showing a 100% efficiency after 50 hours of cycling. FIG. 3 shows the potential as a function of capacity for the first two cycles.

### Example 2

LAGP (85 wt.%) and QPAC®25 (poly(ethylene carbonate), 15 wt.%) were dispersed in N,N-dimethylformamide or a N,N-dimethylformamide:tetrahydrofuran (1:1) mixture. The obtained mixture was applied by Doctor blade on a polypropylene film. The film was then dried at 50° C. for 2 hours.

The cathode was prepared by mixing LAGP (45%), LiFePO₄ (45%) and graphite (10%) using a SPEX® mixer to obtain a mixed positive electrode material. This mixed positive electrode material (85%) and QPAC®25 (15%) were dispersed in N,N-dimethylformamide or a N,N-dimethylformamide:tetrahydrofuran (1:1) mixture. The obtained mixture was applied as a film by Doctor blade on a polypropylene film. The cathode thus formed was dried at 50° C. for 2 hours.

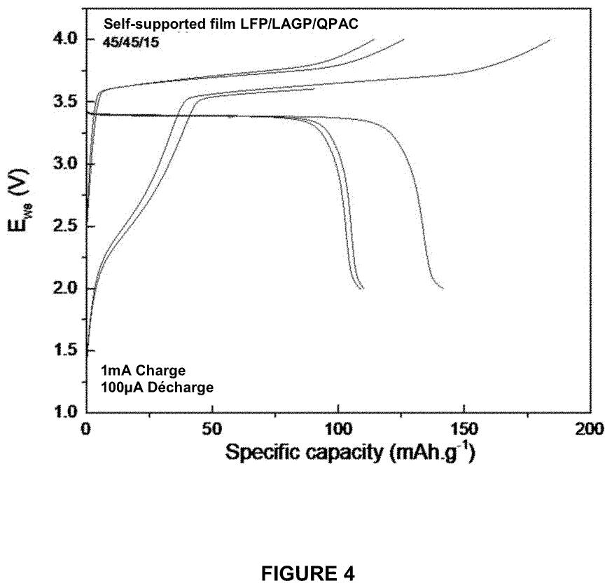

The self standing LAGP electrolyte and cathode films were then separated from the polypropylene films and laminated together at 80° C. to reduce porosity and obtain a ceramic-cathode film having a thickness of between 100 and 400 μm. The film was then pounced and hot-pressed at 700° C. applying a pressure of 112 MPa for 1 hour. The hot-pressed solid ceramic electrolyte-cathode component was cycled with lithium metal and the results are shown in FIG. 4.

Numerous modifications could be made to any of the embodiments described above without departing from the scope of the present invention. All references, patents or scientific literature documents referred to in the present application are incorporated herein by reference in their entirety for all purposes.

1. A process for preparing a multilayer component comprising a solid electrode layer and a solid electrolyte layer, said process being selected from processes A and B:
A: comprising at least the steps of:
a) preparing the solid electrolyte layer by compressing ceramic particles;
b) preparing a mixture comprising at least an electrochemically active material, ceramic particles, and an electron conductive material, the mixture being free of solvent;
c) applying the mixture prepared in (b) on the solid electrolyte layer prepared in (a) to obtain a bilayer material; and
d) pressing the bilayer material obtained in (c) at a pressure of at least 50 kg/cm² and a temperature within the range of about 400° C. to about 900° C.; or
B: comprising at least the steps of:
a) preparing an electrolyte composition layer by applying a mixture of ceramic particles and a polymer on a first support;
b) preparing a mixture comprising at least an electrochemically active material, ceramic particles, an electron conductive material, and optionally a polymer;
c) applying the electrode material mixture prepared in step (b):
i. on the electrolyte composition layer prepared in (a); or
ii. on a second support followed by contacting a surface of the applied electrode material mixture with a surface of the electrolyte composition layer;
to afford a bilayer material;
d) pressing the bilayer material obtained in (c) at a pressure of at least 50 kg/cm² and a temperature within the range of about 400° C. to about 900° C.;
wherein the solid electrolyte layer and the electrode layer are preferably free of polymer after step (d).

2. The process of claim 1, wherein step (a) excludes the addition of a solvent and/or excludes the addition of a lithium salt.

3-4. (canceled)

5. The process of claim 1, wherein the ceramic of step (a) of formula and/or the ceramic particles of step (b) comprise a ceramic of formula Li _{1+z}Al_{z}M_{2-z})(PO₄)₃, wherein M is Ti, Ge, or a combination thereof, and z is such that 0<z<1, preferably M is Ge or M is Ti.

6-7. (canceled)

8. The process of claim 1, wherein step (a) of process A is carried out in the presence of oxygen (e.g., in air) and/or is carried out at a pressure within the range of 100 kg/cm² to 5000 kg/cm²; or step (a) of process B further comprises pressing the mixture in the presence of oxygen (e.g., under air), preferably at a pressure within the range of 100 kg/cm² to 5000 kg/cm².

9. (canceled)

10. The process of claim 1, wherein step (d) is carried out:
in an inert atmosphere (such as argon or nitrogen); and/or
at a pressure in the range of 50 kg/cm² to 5000 kg/cm², or of 100 kg/cm² to 5000 kg/cm², or of 300 kg/cm² to 2000 kg/cm²; and/or
at a temperature of within the range of about 450° C. to about 850° C., preferably from about 600° C. to about 700° C. for process A, or preferably from about 600° C. to about 750° C. for process B; and/or
for a period of more than 0 hour and less than 10 hours, or between 30 minutes and 5 hours, or between 30 minutes and 2 hours.

11-13. (canceled)

14. The process of claim 1, wherein the preparation of the mixture in step (b) is carried out by ball milling.

15. The process of claim 1, wherein the electrode is a positive electrode, preferably the electrochemically active material is selected from phosphates (e.g. LiM^{a}PO₄ where M^{a} is Fe, Ni, Mn, Co, or a combination thereof), oxides and complex oxides such as LiMn₂O₄, LiM^{b}O₂ (M^{b} being Mn, Co, Ni, or a combination thereof), and Li(NiM^{c})O₂ (M^{c} being Mn, Co, Al, Fe, Cr, Ti, Zr, or a combination thereof), elemental sulfur, elemental selenium, iron(III) fluoride, copper(II) fluoride, lithium iodide, and iodine, preferably the electrochemically active material is a phosphate of formula LiM^{a}PO₄ where M^{a} is Fe, Mn, Co or a combination thereof (e.g., LiFePO₄), wherein said electrochemically active material is made of particles optionally further coated with carbon.

16-17. (canceled)

18. The process of claim 1, wherein the conductive electron material is selected from the group consisting of carbon black, Ketjen™ black, acetylene black, graphite, graphene, carbon fibers or nanofibers, carbon nanotubes, and a combination thereof, preferably the electron conductive material comprises carbon fibers (such as VGCF) or the electron conductive material comprises graphite.

19-22. (canceled)

23. The process of claim 1, wherein the ceramic of step (a) and the ceramic particles of step (b) are identical.

24-25. (canceled)

26. The process of claim 1, wherein step (a) of process B further comprises a solvent and comprises drying the mixture after application and/or further comprises removing the first support.

27-28. (canceled)

29. The process of claim 1, wherein in process B the polymer of step (a) and of step (b) if present is, independently in each occurrence, selected from a fluorinated polymer (such as le polyvinylidene fluoride (PVDF), or poly(vinylidene fluoride-co-hexafluoropropylene) (PVDF-HFP)), a poly(alkylene carbonate) (such poly(ethylene carbonate) or poly(propylene carbonate)), a polyvinyl butyral (PVB), or a polyvinyl alcohol (PVA), preferably the polymer is a poly(alkylene carbonate) (such as poly(ethylene carbonate) or poly(propylene carbonate)).

30-36. (canceled)

37. The process of claim 1, wherein said process B comprises step (c) (ii) and the process comprises removing the first support and the second support before contacting; or said process B comprises step (c) (ii) and the process comprises removing the first support and the second support after contacting and before step (d).

38. (canceled)

39. The process of claim 1, wherein the process B further comprises a step of laminating the bilayer material between rolls before step (d).

40. The process of claim 1, wherein step (b) of process B further comprises a solvent and step (c) further comprises drying the applied electrode material; or step (b) of process B comprises dry mixing the electrochemically active material, ceramic particles, and electron conductive material, suspending the resulting mixture with a polymer in a solvent, and step (c) further comprises drying the applied electrode material.

41-56. (canceled)

57. A multilayer component obtained by a process as defined in claim 1.

58. A multilayer component comprising a solid electrode layer and a solid electrolyte layer, wherein:
the solid electrolyte layer comprises ceramic particles;
the solid electrode layer comprises an electrochemically active material, ceramic particles, and an electron conductive material; and
the solid electrode layer and the solid electrolyte layer are free of electrolyte polymer and polymer binder.

59. The multilayer component of claim 58, wherein the ceramic in the solid electrolyte layer is of formula and/or the ceramic particles of step (b) comprise a ceramic of formula Li_{1+z}Al_{z}M_{2-z}(PO₄)₃, wherein M is Ti, Ge, or a combination thereof, and 0<z<1 , preferably M is Ge or M is Ti.

60-61. (canceled)

62. The multilayer component of claim 58, wherein the electrode layer is a positive electrode layer, preferably the electrochemically active material is selected from phosphates (e.g. LiM^{a}PO₄ where M^{a} is Fe, Ni, Mn, Co, or a combination thereof), oxides and complex oxides such as LiMn₂O₄, LiM^{b}O₂ (M^{b} being Mn, Co, Ni, or a combination thereof), and Li(NiM^{c})O₂ (M^{c} being Mn, Co, Al, Fe, Cr, Ti, Zr, or a combination thereof), elemental sulfur, elemental selenium, iron(III) fluoride, copper(II) fluoride, lithium iodide, and iodine, preferably the electrochemically active material is a phosphate of formula LiM^{a}PO₄ where M^{a} is Fe, Mn, Co or a combination thereof (such as LiFePO₄), wherein said electrochemically active material is made of particles optionally coated with carbon.

63-64. (canceled)

65. The multilayer component of claim 58, wherein the conductive material is selected from the group consisting of carbon black, Ketjen™ black, acetylene black, graphite, graphene, carbon fibers or nanofibers, carbon nanotubes, and a combination thereof, preferably the electron conductive material comprises carbon fibers (such as VGCF) or comprises graphite.

66-70. (canceled)

71. The multilayer component of claim 58, wherein the ceramic particles in the solid electrolyte layer and the ceramic particles in the solid electrode layer are identical.

72. The multilayer component of claim 58, comprising a high contact at the interface between the solid electrolyte layer and the solid electrode layer and/or wherein at least one layer of the multilayer component has a density of at least 90% of the theoretical density.

73. (canceled)

74. Electrochemical cell comprising a negative electrode, a positive electrode and an electrolyte, wherein the electrolyte and positive electrode together form a multilayer component as defined in claim 58, preferably the negative electrode comprises a lithium or lithium alloy film and a polymer interlayer between the lithium or lithium alloy film and the solid electrolyte layer, the polymer interlayer preferably comprising a polyether polymer and a lithium salt, such as an optionally crosslinked PEO-based polymer and a lithium salt (e.g. LiTFSI).

75-76. (canceled)

77. Process for preparing an electrochemical cell comprising the steps of:
(i) preparing a multilayer component according to a process as defined in claim 1; and
(ii) assembling the multilayer component of step (i) with a negative electrode layer.

78. The process of claim 77, wherein the negative electrode layer comprises a lithium or lithium alloy film and a polymer interlayer between the lithium or lithium alloy film and the solid electrolyte layer, the polymer interlayer preferably comprising a polyether polymer and a lithium salt, such as an optionally crosslinked PEO-based polymer and a lithium salt (such as LiTFSI

79. (canceled)

80. A battery comprising at least one electrochemical cell as defined in claim 74, said battery preferably being a lithium battery or a lithium-ion battery.

81. (canceled)

82. The multilayer component of claim 57, comprising a high contact at the interface between the solid electrolyte layer and the solid electrode layer and/or wherein at least one layer of the multilayer component has a density of at least 90% of the theoretical density.

83. Electrochemical cell comprising a negative electrode, a positive electrode and an electrolyte, wherein the electrolyte and positive electrode together form a multilayer component as defined in claim 57, preferably the negative electrode comprises a lithium or lithium alloy film and a polymer interlayer between the lithium or lithium alloy film and the solid electrolyte layer, the polymer interlayer preferably comprising a polyether polymer and a lithium salt, such as an optionally crosslinked PEO-based polymer and a lithium salt (e.g. LiTFSI).

84. A battery comprising at least one electrochemical cell as defined in claim 83, said battery preferably being a lithium battery or a lithium-ion battery.
